(19) United States
(12) Patent Application Publication
(10) Pub. No.: US 2026/0321994 A1
(43) Pub. Date: Oct. 15, 2026

(54) ELECTRICAL CONNECTION ASSEMBLY AND CONNECTOR

(71) Applicant: Tyco Electronics (Shanghai) Co., Ltd., Shanghai (CN)

(72) Inventors: Dalei (Otto) Chen, Shanghai (CN); Hongbo (Daniel) Zhang, Shanghai (CN); Bo (Leo) Chen, Shanghai (CN); Tongbao (Tim) Ding, Shanghai (CN); Yongjian (Justin) Huang, Shanghai (CN)

(73) Assignee: Tyco Electronics (Shanghai) Co., Ltd., Shanghai (CN)

(21) Appl. No.: 19/646,738

(22) Filed: Apr. 14, 2026

(30) Foreign Application Priority Data
Apr. 15, 2025 (CN) 202510472456.6

(51) Int. Cl. H01R 4/20; H01R 4/18; H01R 4/70

(52) U.S. Cl. CPC H01R 4/20; H01R 4/183; H01R 4/70

(57) ABSTRACT

An electrical connection assembly includes a cable, a sealing element, and a terminal. The cable has an outer insulation layer and an exposed conductor core. The sealing element has a cylindrical shape. The sealing element includes a sealing part and a crimping part. The sealing part is fitted onto the outer insulation layer. The crimping part is fitted onto the exposed conductor core. The terminal has a first crimping part and a second crimping part. The first crimping part is crimped onto the exposed conductor core. The second crimping part is crimped onto the crimping part of the sealing element. The sealing part of the sealing element is compressed between the outer insulation layer and an inner peripheral surface of an insertion hole of a housing to achieve sealing between the two.

### CROSS-REFERENCE TO RELATED APPLICATION

This application claims the benefit of the filing date under 35 U.S.C. § 119(a)-(d) of Chinese Patent Application No. CN202510472456.6 filed on Apr. 15, 2025, the whole disclosure of which is incorporated herein by reference.

### FIELD OF THE INVENTION

The present invention relates to an electrical connection assembly and, more particularly, to an electrical connection assembly and a connector comprising the electrical connection assembly.

### BACKGROUND OF THE INVENTION

A connector typically includes a housing and an electrical connection assembly inserted into an insertion hole of the housing. The electrical connection assembly typically includes a cable, a sealing element, and a terminal. The sealing element is cylindrical in shape and is fitted onto the outer insulation layer of the cable. The sealing element has a sealing part and a crimping part that are axially connected. Inner and outer sealing ribs are respectively formed on the inner and outer surfaces of the sealing part. The inner sealing rib is interference fit with the outer insulation layer of the cable, and the outer sealing rib is interference fit with the inner peripheral surface of the insertion hole of the housing. The terminal includes a first crimping part that is crimped onto the exposed conductor core of the cable and a second crimping part that is crimped onto the crimping part of the sealing element. Typically, due to the crimping part of the sealing element being fitted onto the outer insulation layer of the cable, the size of the second crimping part of the terminal in the transverse and height directions of the housing is relatively large, which increases the pitch between adjacent terminals and the transverse and height dimensions of the connector, which is not conducive to the miniaturization of the connector.

### SUMMARY OF THE INVENTION

An electrical connection assembly includes a cable, a sealing element, and a terminal. The cable has an outer insulation layer and an exposed conductor core. The sealing element has a cylindrical shape. The sealing element includes a sealing part and a crimping part. The sealing part is fitted onto the outer insulation layer. The crimping part is fitted onto the exposed conductor core. The terminal has a first crimping part and a second crimping part. The first crimping part is crimped onto the exposed conductor core. The second crimping part is crimped onto the crimping part of the sealing element. The sealing part of the sealing element is compressed between the outer insulation layer and an inner peripheral surface of an insertion hole of a housing to achieve sealing between the two.

### BRIEF DESCRIPTION OF DRAWINGS

The invention will now be described by way of example with reference to the accompanying figures, of which:

FIG. 1 is a perspective view of an electrical connection assembly according to an exemplary embodiment;

FIG. 2 is an exploded view of the electrical connection assembly of FIG. 1;

FIG. 3 is an axial sectional view of the electrical connection assembly of FIG. 1;

FIG. 4 is an axial sectional view of a sealing element of the electrical connection assembly of FIG. 1;

FIG. 5 is a transverse sectional view of the electrical connection assembly of FIG. 1;

FIG. 6 is a plan sectional view of the electrical connection assembly of FIG. 1; and

FIG. 7 is a plan view of adjacent terminal components in a connector according to an exemplary embodiment.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

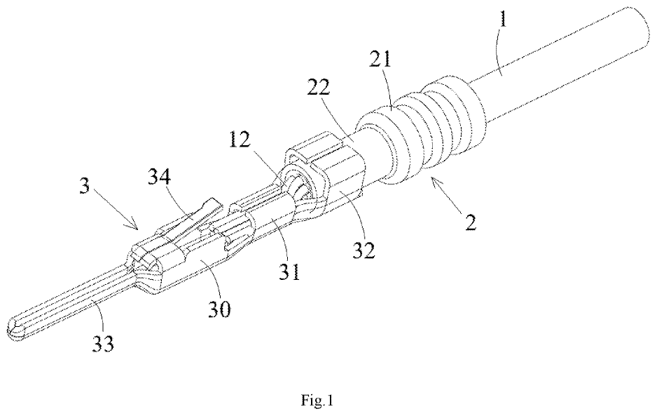

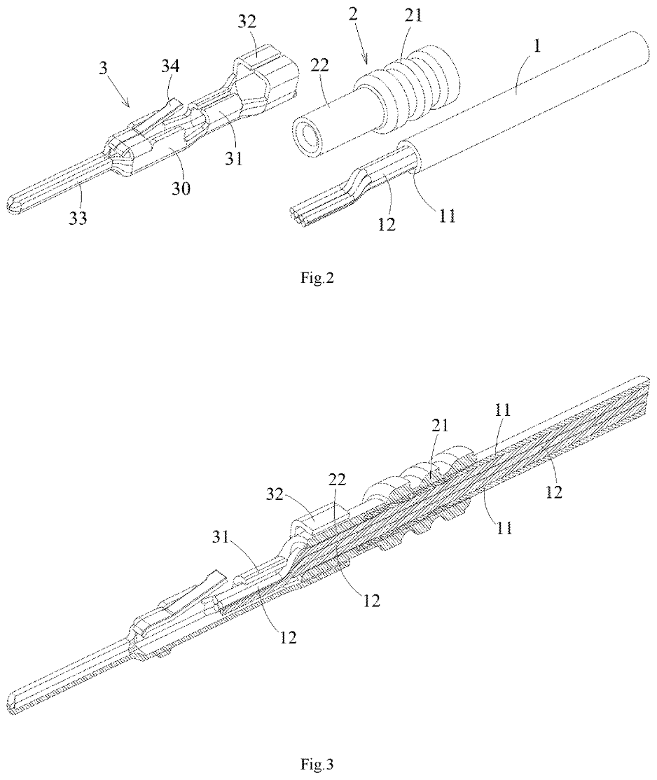

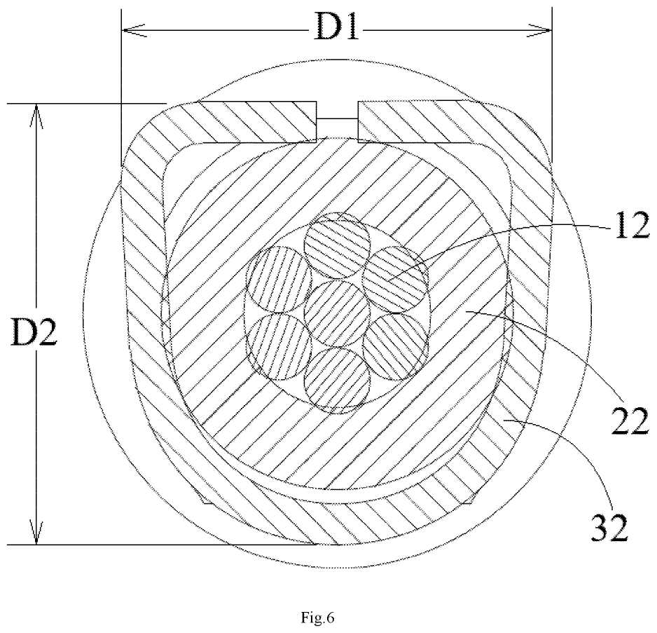

An exemplary embodiment of an electrical connection assembly will now be described with reference to FIGS. 1-7. As shown in FIGS. 1-2, the electrical connection assembly includes a cable 1, a sealing element 2, and a terminal 3. The sealing element 2 is cylindrical in shape. The sealing element 2, as shown in FIGS. 1-5, includes a sealing part 21 and a crimping part 22 that are axially connected. As shown in FIG. 3, the sealing part 21 of the sealing element 2 is fitted onto the outer insulation layer 11 of the cable 1, and the crimping part 22 of the sealing element 2 is fitted onto the exposed conductor core 12 of the cable 1.

As shown in FIGS. 1-3, the terminal 3 includes a first crimping part 31 and a second crimping part 32. The first crimping part 31 of the terminal 3 is crimped onto the exposed conductor core 12 of the cable 1 to electrically connect with the exposed conductor core 12. The second crimping part 32 of the terminal 3 is crimped onto the crimping part 22 of the sealing element 2. The sealing part 21 of the sealing element 2 is suitable for being compressed between the outer insulation layer 11 of the cable 1 and the inner peripheral surface of the insertion hole of the housing to achieve sealing between the two.

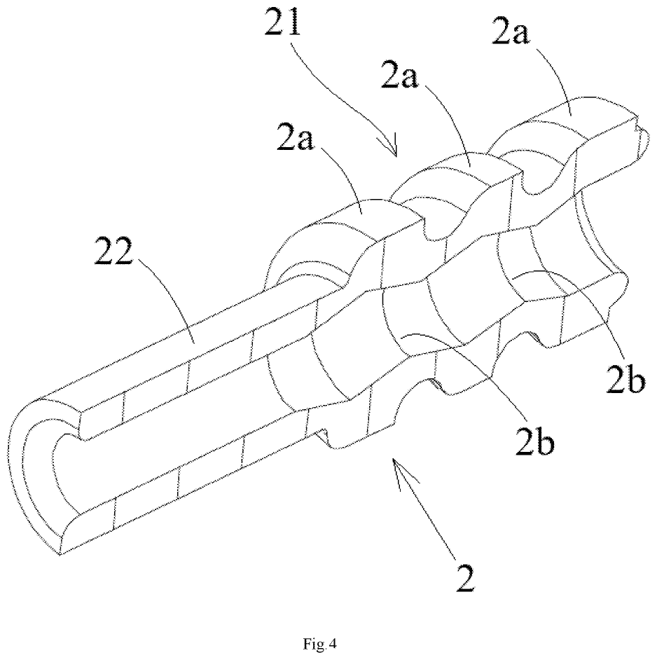

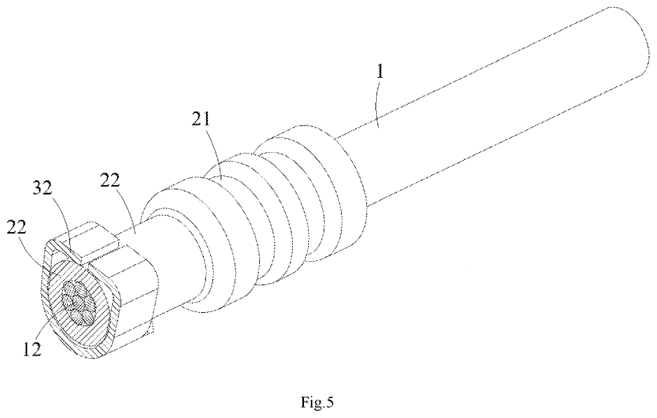

As shown in FIG. 4, multiple circles of outer sealing ribs 2a are formed on the outer peripheral surface of the sealing part 21 of the sealing element 2. The multiple circles of outer sealing ribs 2a are spaced apart in the axial direction of the sealing element 2 for interference fit with the inner peripheral surface of the insertion hole of the housing.

As shown in FIGS. 1 to 7, multiple circles of inner sealing ribs 2b are formed on the inner peripheral surface of the sealing part 21 of the sealing element 2. The multiple circles of inner sealing ribs 2b are spaced apart in the axial direction of the sealing element 2 for interference fit with the outer peripheral surface of the outer insulation layer 11 of the cable 1. The inner diameter of the crimping part 22 of the sealing element 2 is equal to or slightly smaller than the outer diameter of the exposed conductor core 12 of the cable 1, and the outer diameter of the crimping part 22 of the sealing element 2 is slightly larger than the outer diameter of the outer insulation layer 11 of the cable 1.

As shown in FIGS. 1 and 3, a part of the exposed conductor core 12 of the cable 1 extends from the crimping part 22 of the sealing element 2, and the first crimping part 31 of the terminal 3 is crimped onto the exposed conductor core 12 of the cable 1 extending from the crimping part 22 to electrically connect the terminal 3 to the exposed conductor core 12 of the cable 1.

As shown in FIGS. 1-2, the terminal 3 also includes a mating part 33 and a fixing part 30. The mating part 33 of the terminal 3 is used to mate with a mating terminal. The fixing part 30 of the terminal 3 is used to fix it into the insertion hole of the housing. The mating part 33 and the first crimping part 31 are respectively connected to the two ends of the fixing part 30.

As shown in FIGS. 1-2, a locking spring 34 is formed on the fixing part 30 of the terminal 3, which is used for engaging the housing to lock the terminal 3 in the insertion hole of the housing.

As shown in FIGS. 1-2, the terminal 3 is a male terminal, and the mating part 33 of the terminal 3 is needle shaped and suitable for insertion into the mating terminal to make electrical contact with it. However, the present invention is not limited to the illustrated embodiments. For example, in another exemplary embodiment of the present invention, the terminal 3 may be a female terminal, and the mating part 33 of the terminal 3 may be cylindrical and suitable for electrical contact with the mating terminal inserted into it.

As shown in FIG. 2, the sealing element 2 can be an integral injection molded part. This can reduce manufacturing costs and improve manufacturing efficiency. As further shown in FIG. 2, the terminal 3 can be an integral stamped part. This can reduce manufacturing costs and improve manufacturing efficiency.

An exemplary embodiment of a connector will now be described with reference to FIGS. 1-7. The connector includes a housing and the aforementioned electrical connection assembly. An insertion hole is formed in the housing. The electrical connection assembly is inserted into the insertion hole of the housing. The sealing part 21 of the sealing element 2 is compressed between the outer insulation layer 11 of the cable 1 and the inner peripheral surface of the insertion hole of the housing to achieve sealing between the two.

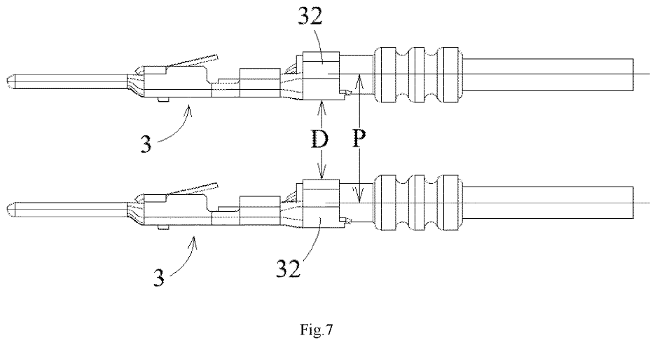

Multiple insertion holes are formed in the housing, and the connector includes multiple electrical connection assemblies, as shown in FIG. 7, that are respectively inserted into the multiple insertion holes. There is a predetermined distance D between the second crimping parts 32 of adjacent terminals 3.

As shown in FIGS. 1 and 3, the crimping part 22 of the sealing element 2 is fitted onto the exposed conductor core 12 of the cable 1, rather than onto the outer insulation layer 11 of the cable 1. Therefore, it is possible to reduce the size of the second crimping part 32 of the terminal 3 crimped onto the crimping part 22 of the sealing element 2. As shown in FIGS. 6-7, the reduction in the lateral dimension D1 of the second crimping part 32 of the terminal 3 is equal to twice the thickness of the outer insulation layer 11 of the cable 1, the reduction in the height dimension D2 of the second crimping part 32 of the terminal 3 is equal to twice the thickness of the outer insulation layer 11 of the cable 1, and the reduction in the pitch P between adjacent terminals of the connector is equal to twice the thickness of the outer insulation layer 11 of the cable 1. Therefore, the present invention can reduce the lateral and height dimensions of the connector.

In the aforementioned exemplary embodiments according to the present invention, the crimping part 22 of the sealing element 2 is fitted onto the exposed conductor core 12 of the cable 1, rather than onto the outer insulation layer 11 of the cable 1. Therefore, it is possible to reduce the size of the second crimping part 32 of the terminal 3 crimped onto the crimping part 22 of the sealing element 2, thereby reducing the pitch P between adjacent terminals of the connector and the size of the connector.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. An electrical connection assembly, comprising:
a cable having an outer insulation layer and an exposed conductor core;
a sealing element having a cylindrical shape, the sealing element includes a sealing part and a crimping part, the sealing part is fitted onto the outer insulation layer, the crimping part is fitted onto the exposed conductor core; and
a terminal having a first crimping part and a second crimping part, the first crimping part is crimped onto the exposed conductor core, the second crimping part is crimped onto the crimping part of the sealing element, the sealing part of the sealing element is compressed between the outer insulation layer and an inner peripheral surface of an insertion hole of a housing to achieve sealing between the two.

2. The electrical connection assembly of claim 1, wherein a plurality of circular outer sealing ribs are formed on an outer peripheral surface of the sealing part of the sealing element, the circular outer sealing ribs are spaced apart in an axial direction of the sealing element and are interference fit with the inner peripheral surface of the insertion hole of the housing.

3. The electrical connection assembly of claim 1, wherein a plurality of circular inner sealing ribs are formed on an inner peripheral surface of the sealing part of the sealing element, the circular inner sealing ribs are spaced apart in an axial direction of the sealing element and are interference fit with an outer peripheral surface of the outer insulation layer.

4. The electrical connection assembly of claim 1, wherein an inner diameter of the crimping part of the sealing element is equal to an outer diameter of the exposed conductor core.

5. The electrical connection assembly of claim 1, wherein an inner diameter of the crimping part of the sealing element is smaller than an outer diameter of the exposed conductor core.

6. The electrical connection assembly of claim 4, wherein an outer diameter of the crimping part of the sealing element is larger than an outer diameter of the outer insulation layer.

7. The electrical connection assembly of claim 5, wherein an outer diameter of the crimping part of the sealing element is larger than an outer diameter of the outer insulation layer.

8. The electrical connection assembly of claim 1, wherein a part of the exposed conductor core extends from the crimping part of the sealing element.

9. The electrical connection assembly of claim 8, wherein the first crimping part of the terminal is crimped onto the exposed conductor core extending from the crimping part to electrically connect the terminal to the exposed conductor core.

10. The electrical connection assembly of claim 1, wherein the terminal further includes a mating part and a fixing part, the mating part mates with a mating terminal, the fixing part fixes into the insertion hole of the housing, the mating part and the first crimping part are respectively connected to both ends of the fixing part.

11. The electrical connection assembly of claim 10, wherein a locking spring is formed on the fixing part of the terminal, the locking spring engages with the housing to lock the terminal in the insertion hole of the housing.

12. The electrical connection assembly of claim 10, wherein the mating part of the terminal is needle shaped and is inserted into the mating terminal to electrically contact the mating terminal.

13. The electrical connection assembly of claim 10, wherein the mating part of the terminal is cylindrical, the mating part electrically contacts the mating terminal inserted into the mating part.

14. The electrical connection assembly of claim 1, wherein the sealing element is an integral injection molded part.

15. The electrical connection assembly of claim 1, wherein the terminal is an integral stamped part.

16. The electrical connection assembly of claim 1, wherein a reduction in a lateral dimension of the second crimping part is equal to twice a thickness of the outer insulation layer due to the crimping part being fit onto the exposed conductor core.

17. The electrical connection assembly of claim 1, wherein a reduction in a height dimension of the second crimping part is equal to twice a thickness of the outer insulation layer due to the crimping part being fit onto the exposed conductor core.

18. A connector, comprising:
a housing formed with an insertion hole; and
an electrical connection assembly including a cable, a sealing element, and a terminal, the cable has an outer insulation layer and an exposed conductor core, the sealing element has a cylindrical shape, the sealing element includes a sealing part and a crimping part, the sealing part is fitted onto the outer insulation layer, the crimping part is fitted onto the exposed conductor core, the terminal has a first crimping part and a second crimping part, the first crimping part is crimped onto the exposed conductor core, the second crimping part is crimped onto the crimping part of the sealing element, the electrical connection assembly is inserted into the insertion hole of the housing, the sealing part of the sealing element is compressed between the outer insulation layer and an inner peripheral surface of the insertion hole of the housing to achieve sealing between the two.

19. The connector of claim 18, wherein a plurality of insertion holes are formed in the housing, and the connector comprises a plurality of electrical connection assemblies that are respectively inserted into insertion holes, a predetermined spacing is between the second crimping parts of adjacent terminals.

20. The connector of claim 19, wherein a reduction in a pitch between adjacent terminals of the connector is equal to twice a thickness of the outer insulation layer of one cable due to each crimping part being fit onto one exposed conductor core.
